(19) United States
(12) Patent Application Publication
(10) Pub. No.: US 2020/0050469 A1
(43) Pub. Date: Feb. 13, 2020

(54) A METHOD AND SYSTEM FOR CREATING MULTI MOBILEPHONE ENVIRONMENTS AND NUMBERS ON A SINGLE HANDSET WITH SINGLE SIM-CARD

(71) Applicant: PRIVACY SOFTWARE SOLUTIONS LTD., Shoham (IL)

(72) Inventor: Tzachi Zack, Shoham (IL)

(73) Assignee: PRIVACY SOFTWARE SOLUTIONS LTD., Shoham (IL)

(21) Appl. No.: 16/485,807

(22) PCT Filed: Feb. 21, 2018
(86) PCT No.: PCT/IL2018/050196

§ 371 Date: Aug. 14, 2019

Related U.S. Application Data
(60) Provisional application No. 62/461,256, filed on Feb. 21, 2017.

(51) Int. Cl. G06F 9/455; G06F 9/445; G06F 8/60

(52) U.S. Cl. CPC G06F 9/45558; G06F 8/60; G06F 9/4451

(57) ABSTRACT

A method of creating a second virtual environment in a mobile device (such as a mobile phone) with a single sim-card and a main environment, according to which a second phone environment is created, so as to eliminate the need to use two physical phones. A second phone number is added on the same smart phone module and the second environment is associated with new user accounts, such as emails and social application; Then the second added phone number is associated with text messaging accounts such as SMS's and WhatsApp. The method uses client software, a data base server, a Direct Inward Dialing (DID) provider, an application server and storage server. The DID provider provides the DID numbers and a set of APPs which communicates with the data base server. The server side contains sets of tables with end users information and transactions such as user phone number, email, name, location of user's files in the storage, user configurations such as geolocation settings and scheduler. The Application server executes back-end user programs and the storage server is the user back-ups and contains user files, such as pictures, contacts, messages etc. The method performs hardware virtualization as a system that is run as third-party software that emulates and shares hardware resources with the main Operating System (OS) and defines a set of required permissions which can be selected manually by developers during tests on different devices. The proposed hardware virtualization runs a guest operation system and clones applications inside it which are run as Intents in the host OS.

### FIELD OF THE INVENTION

The present invention relates to the field of mobile smartphones applications for virtually adding a second (or more) environments within the same smartphone unit. More specifically, the present invention relates to the field of full virtualization of mobile phone with Direct Inward Dialing (DID) phone number.

### BACKGROUND OF THE INVENTION

In the modern world, a person may be interested in adding a second (or more) phone environment within his existing smartphone unit. In order to have a full virtual phone environment with a verity of smartphone's applications, a person may be interested to also have a second phone number (DIDs) for second identification, outgoing and incoming phone calls and text messages. Direct inward dialing numbers (DIDs) are virtual numbers that allow the user to route calls to his existing telephone lines, without requiring multiple physical phone lines.

For example, a person may want to have one environment with one number for a private use and another environment with a second number for business or other purposes. He may also want to hide the second environment with the second number, so who ever looks into his main physical mobile phone, will not be able to identify any second (or more) phone environment with a second number.

Prior art documents disclose adding a virtual environment by using a partition algorithm where the resources of the smartphone unit are divided between the physical environment and the virtual environment, where a fix amount of resources is allocated for the virtual environment. The use of this algorithm leads to limited performance of each Operation System of the physical and virtual environment, and it also cause that only one Operation System (OS) can use the communication layer every time.

Therefore, there is a need to keep the main-physical environment and phone-line active in parallel to enabling the other virtual environment/s and phone-line/s active. This, to enable availability, sending and receiving phone-calls, e-mails, massages and notification in all person's environments and phone-lines.

It is therefore an object of the invention to provide a method for full virtualization of a second (or more) environment added to a smartphone unit, where the communication is available to all the environments, physical and virtual in parallel.

Other objects and advantages of the invention will become apparent as the description proceeds.

### SUMMARY OF THE INVENTION

The present invention is directed to a system for creating one or more additional virtual environment in a mobile device, with a host Operation System operating in a host environment, which comprises:
a. a client application for allowing the user to interface with the additional virtual environment;
b. a server application with a backend system management unit, which communicates with the client application and manages the operations of the client application;
c. a server data base which contains sets of tables with end users information and transactions;
d. a DID provider which provides the DID numbers and a set of API's which communicates with the server DB;
e. a communication sub-system which manages the communication of the virtual environment;
f. a storage server which contains user files containing user related data which is generated by the user; and
g. a virtualization engine which enables a degree of virtualization of the client application,
   wherein the client application is downloaded to the mobile device, and requests a resources allocation according to a predetermined threshold from the host Operation System to emulate a virtual Operation System; the client application is installed in the virtualization engine and collects data parameters and setting of the mobile device and information about the user; the server application preinstalls applications to be executed by the virtual environment of the user according to the user profile and to the collected data parameters and setting and the user information, wherein the backend system management unit generates a sandbox for running the client application to isolate the virtual Operation System and the client application from the host Operation system and to avoid access of the host Operation System to the resources allocated to the client application thereby creating an additional virtual environment; and requesting allocation of resources on demand from the host Operation System to run applications in the virtual environment according to the parameters and settings of the mobile device and according to the user profile data and information.

The mobile device with the virtual environment may have a second phone number with a single sim-card.

The communication sub-system may comprise VOIP media relays servers, SIP proxy server, push messaging unit a PBX and voice engine and a communication management and billing unit and a backend system management unit.

The additional virtual environment may be secured and hidden from unauthorized persons.

In one aspect, the server application creates a new identity for the user so that the additional environment contains an additional phone number and line with messages and applications that are already downloaded on the main environment of the mobile device.

The additional virtual environment may comprise several layers of security to the user, for hiding private information and identities from people related to the user.

The system may further comprise a camera on the additional environment which automatically stores pictures in a safe and hidden repository.

The present invention is also directed to a method for creating one or more additional virtual environment in a mobile device, with a host environment and a host Operation System, the method comprises the steps of:
a. downloading a client application to the mobile device and registering to the application to create a user profile, which is saved in a server application which manages the operations of the client application and gaining access to a virtualization engine from the host Operation System;
b. requesting resources allocation from the host Operation System according to a predefined threshold to emulate a virtual Operation System, serving the virtual environment, enabling the virtual Operation System to run one or more applications;
c. collecting data parameters and setting of the mobile device;
d. collecting information about the user;
e. pre-installing applications and mobile environment of the user according to the user profile and to the collected data and information;
f. isolating the virtual Operation System to avoid access of the host operation System to the resources allocated to the client application by generating a sandbox for running the dedicated client application thereby creating a virtual environment; and
g. requesting allocation of resources on demand from the host Operation System to run applications in the virtual environment, according to the parameters and settings of the mobile device and according to the user profile data and information.

### BRIEF DESCRIPTION OF THE DRAWINGS

These and further features and advantages of the invention will become more clearly understood in the light of the ensuing description of a some embodiments thereof, given by way of example only, with reference to the accompanying figures, wherein:

FIG. 1 is a schematic block diagram illustration of a second mobile identity, according to some embodiments of the invention;

FIG. 2 is a flowchart illustration of a second mobile identity and phone number method, according to some embodiments of the invention; and

FIG. 3 is a schematic diagram of the entire system of the present invention with the communication sub-system according to an embodiment of the present invention.

The drawings taken with the descriptions thereof make apparent to those skilled in the art how the invention may be embodied in practice.

Further, where considered appropriate, reference numerals may be repeated among the figures to indicate identical elements.

### DETAILED DESCRIPTION OF SOME EMBODIMENTS OF THE INVENTION

The present invention discloses a method for virtually adding and creating a second (or more) environment within the same smartphone unit. In an embodiment of the invention a mobile smartphone application is downloaded to the smartphone unit to add a second or more virtual environments (which are isolated runtime operating environments that allow applications run without interfering with the behavior of other Python applications running on the same system, and that emulate the operation of an inherent operating environment of the mobile device) to the physical environment of the smartphone.

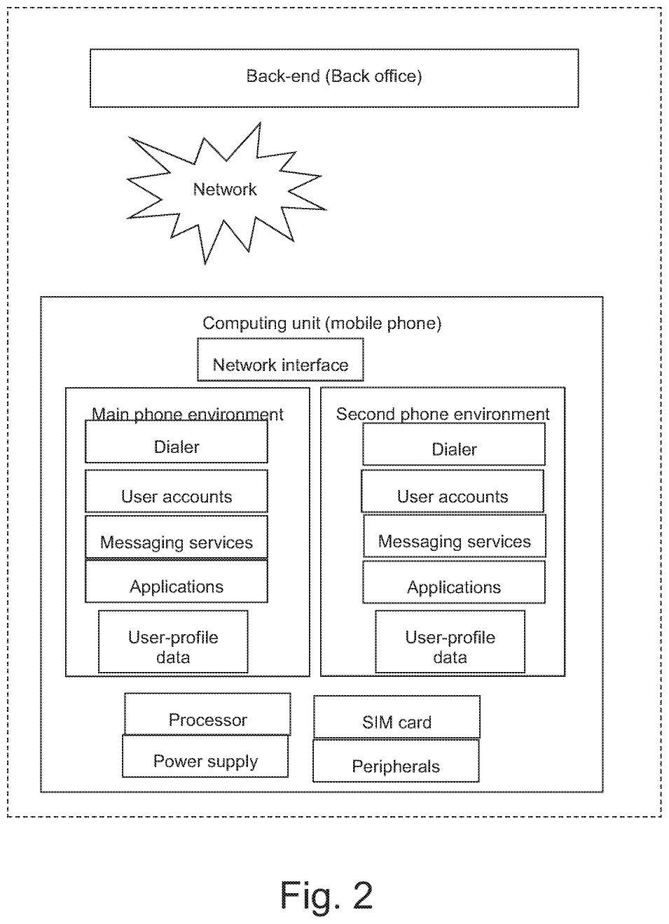

FIG. 2 schematically describes a flowchart illustration of a second mobile identity and phone number method, according to some embodiments of the invention. In an embodiment of the invention, system 200 comprises a computing unit 201, with a network interface 203, and the virtual environment is installed in the computing unit. The virtual environment comprises a dialer 205, user accounts 206, messaging services 207, applications 208, and user profile data, 202. The computing unit 201 is adapted to store therein, inter alia: user-profile data 202, representing at least one set of user-preferences of at least one user; and a plurality of entity-profile data of a person of respective entities. The computing unit 201 may further be adapted to determine the location area of the person. The computing unit 201 may further be adapted to determine the timing of each number and environment to be activated (also referred to scheduling system).

In an embodiment of the invention, the computing unit 201 may determine the level of security the user is asking for. At the highest level of security, the presence of the application may not be visible and will not reveal its activity, in certain conditions, the access to the second environment will be possible only by passing a pre-defined barrier (i.e. through a “back door” application, credentials etc.).

In an embodiment of the invention, the user-preference may comprise data representing parameters of the geographical area.

In embodiments of the invention, the machine-readable medium may further perform the step of receiving information about the second phone environment encapsulation.

The application of the system of the invention creates a “second phone” (or more) environment/s within an existing mobile device, to eliminate the need to carry two devices.

The “second phone” environment is also associated with a new phone number so all duplicated accounts that are generated in the new environment, can be associated to the new phone number so the new identity that is being created has a complete “second phone” environment. For example, it will be possible to dial or send messages from a mobile phone (real) inherent environment to the “second phone” (or more) environment(s) or from an additional virtual environment to other additional virtual environments, like each virtual environment was a real inherent environment.

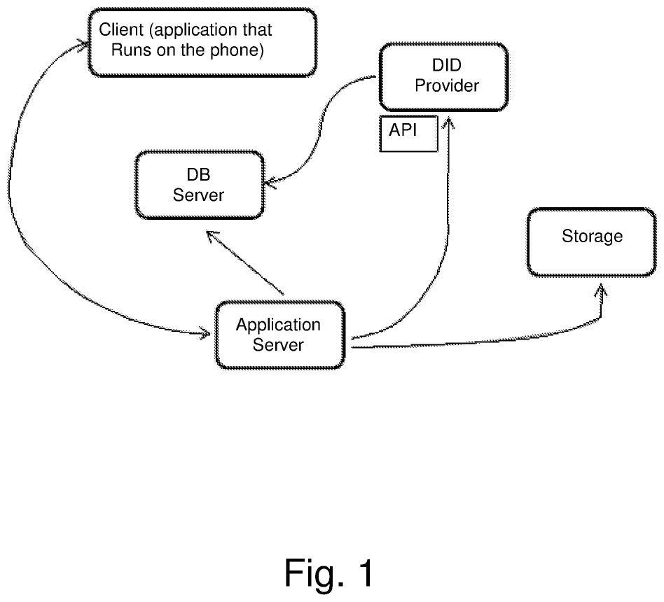

FIG. 1 schematically shows a block diagram of a second mobile identity, according to an embodiment of the present invention. The second virtual environment of the invention comprises, a client software unit 101 which is an application that runs on the mobile device. A data base server 102, which contains sets of tables with end users information and transactions such as: User phone number, email, name etc. The data base also contains location of user's files in the storage, user configurations such as geolocation settings and scheduler. An application server 103 which executes back-end user programs and runs user programs in the background. In case a user runs his virtual environment on a web front-end or a non-Android/iOS environment, the application server runs the user application and presents it to the user as simulation. The client application 101 is always connected to the application data base server 103 and the client application is always managed by the application database server 103. The application server 103 is responsible for: call initiation, receiving, call management, and quality of service. A DID provider 104, which is a wholesale of international numbers, provides the DID numbers and a set of API's which communicates with the server DB, and a storage server 105, which is the user back-ups and the entire encapsulation environment. The storage server 105 contains user files, such as pictures, contacts, messages etc.

The main concept of the present invention is Hardware virtualization (hypervisor). The system of the invention works as a ‘guest operation system’, and put an Operation System (OS) that runs as third-party software that emulates and shares hardware resources with the main OS. The hardware resources of the mobile device are shared on-demand with the guest OS so that both of the Operation Systems are available even in parallel. Thus, the communication is also available for both Operation Systems even in parallel. This means that a phone communication can be executed for example between the two numbers (the number of the mobile device and the number of the virtual environment) of said mobile device.

Whenever a client application is downloaded to a mobile device the host operation system allocates to the downloaded application a virtualization engine in order to enable a predetermined degree of virtualization to the application. In an embodiment of the invention, the present invention uses the allocated virtualization engine as a base for virtualization and then requests resources allocation from the host operation system (the inherent operating system of the mobile device) according to a predefined resource allocation threshold, which is the minimum required for the client application of the invention to emulate a virtual operation system, which serves to create the virtual environment and enables the virtual environment to run different client applications.

Once the virtual engine is allocated to the client application with the requested resources allocation, the backend system management unit generates a sandbox (an isolated computing environment in which a program or file can be executed without affecting the application in which it runs) for the client application to enable isolation of the client application from the host Operation System. The client application and the virtual Operation system run inside the sandbox and thereby, the host Operation System has no access or indications regarding the operations of the client application. Meanwhile, the client application creates a virtual environment with its virtual Operation System which can run all type of client applications including application that already exists on the host device environment. Once the client application and the virtual Operation System are isolated from the host Operation System the virtual environment is established, and the client application requests resources on demand from the host Operation System, for every application that is run on the virtual environment.

In an embodiment of the invention, if the host Operation System is overloaded and cannot allocate resources on demand for the client application, the resources (such as computational power, volatile memory and permanent storage means) can be achieved from an external source such as the Internet, or cloud server for the trade-off of latency for example.

In an embodiment of the present invention, two different Operation Systems can be installed on the same mobile device. For example: a virtual environment of a “Android” OS can be installed in an iPhone device which runs an iPhone OS.

The system of the invention defines a set of required permissions, which can be selected manually by developers during tests on different devices.

In an embodiment of the invention, the client application can be installed on the mobile device, in the following manners:

1) A system that is embedded into the firmware by vendors and requires root privileges; or
2) Cloning of existing applications and replacement of package IDs.

In an embodiment of the invention, the method of the invention comprises the steps of: In the first step, the application 101 is downloaded to the mobile device and the user registers to the application, creating a user profile. The application collects data and information regarding the mobile device such as the model of the mobile device, what Operation System is installed, the what processor etc. the application also collects data about the user for example, the location of the user—and accordingly the application assign a number accordingly, if desirable. According to the data collected, the application knows what relevant application can be pre-install for every user. For example: a user that is connected via a specific company—the application recognizes the company and the workspace of the company is pre-installed in the virtual environment. Then the application 101, of the invention, runs a guest operation system and clones applications from the physical environment of the mobile device inside the guest operation system. This is a post data collection stage. At that stage, the system is ready to host any application from the market, based on the rules and the pre configuration data that was collected before that.

Then in the next step, Google Play services are installed inside the application 101 for the correct work of push notifications, embedded maps, etc.; and in the last step, the cloned applications inside the application 101 are run as Intents. The client application that runs on the main mobile environment scans an app's manifest and runs the needed activity as Intent in the host OS.

After the virtual environment is updated on the mobile device, the application server manages the virtual environment. For example, in case there are too many applications open in the virtual environment, the application server will ask the used to close some of the applications. If there are open tasks, the application server automatically closes part of the tasks (for example: applications which leaves an open port, the application server closes all ports, and leaves only one unified port) In an embodiment of the invention, if the user changes a mobile device to a different mobile device with different settings, the virtual environment can be reinstalled in the different mobile device according to the setting of the new device.

In an embodiment of the invention, the system 100 of the invention includes the client side—with a mobile application 101 which acts as a semi-virtual machine (Apps launcher or Container) over supported mobile phone models; and a server 103 side, which is responsible for:
User accounts: enrollment, billing, integration with 3rd party Apps, backup & restore, etc.
Add-value services: cloud storage, find-new-friends rooms, etc.
Virtual phone lines management
PBX and signaling of calls
Management reports: statistics for technical (e.g. load), accounting and marketing purposes

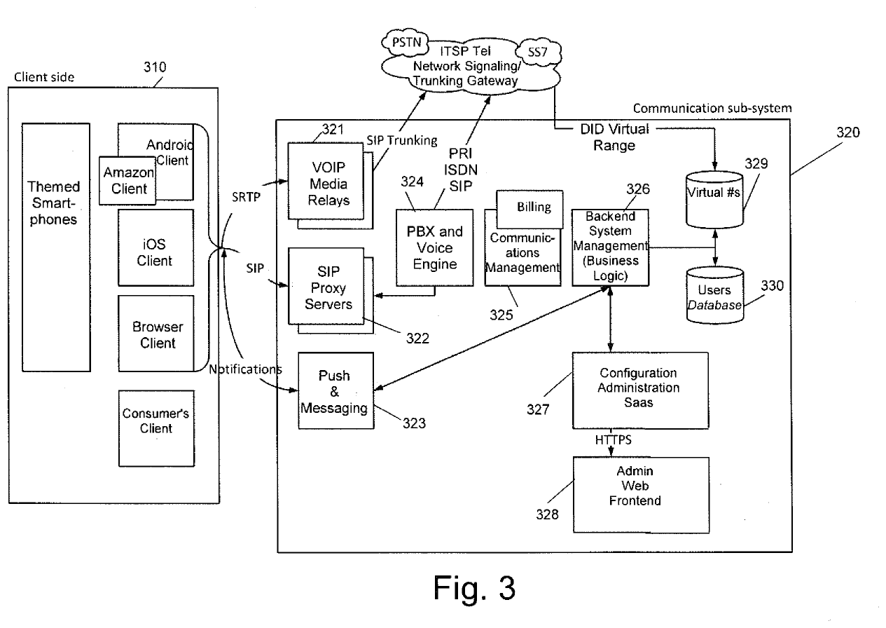

FIG. 3 schematically describes the system of the invention, including the communication sub-system according to an embodiment of the invention. It can be seen that there is a client side 310 and a server side 320 and the communication sub-system is in the server side. In an embodiment of the invention, the communication sub-system comprises VOIP media relays servers 321 which transfer the VOIP over a SIP protocol, and a corresponding SIP proxy server 322. A push messaging unit 323, which pushes messages that arrives to the phone line, in to the system is also a part of the communication sub-system. The push messaging unit 323 allows the client to be in a sleep mode in order to save battery and whenever a new message arrives, the push messaging unit 323 awakes the client to initiate a communication. The push messaging unit 323 is always connected to the backend system management 326, to know the status of the client. In case the client is already awake, the push messaging unit directly transfers the communication and does not have to awake the client. A PBX and voice engine unit 324 is connected to the SIP proxy server 322 and to the backend system management 326. The PBX unit receives and transfers communications, connects number provider and generally serves as a switchboard. A communication management and billing unit 325 manages all the CDR (Call Directory Records) and the billing for the communication. The backend system management 326 is a part of the communication sub-system and of the application server which manages the application (in the client side) and it is always connected to the client. The backend system management 326 is the main management unit which is connected to all the components in the system and manages the system. The backend system management 326 is connected to a configuration administration SaaS 327, which is a web frontend for the clients of the system and to an Admin web frontend 328 which is a portal through which the administrators of the system of the present invention can manages the users and the clients. The backend system management 326 is also connected to the virtual numbers data base 329 and to the user's database 330. The communication sub-system is always connected to the network 340.

In an embodiment of the invention, possible types of clients that can be used are:
1. Mobile Applications, which are the major client type. The mobile applications run presets dynamically, on-demand by the server; it can be updated via the App stores and pick up distribution information and statistics;
2. Mobile Clientless services (via browser), with services given by the application server 103 of the present invention.
3. PC Application—Easy installation of a local application; the PC application is able to be self-updated.
4. Browser Add-on—Run presets dynamically, on-demand by the server; be able to self-update; Support several browsers.

In an embodiment of the invention, the client side application 101, is initiated via an icon or an optional disguising Apps (with password/other stronger authentication) or by dialing a pre-defined sequence on the dialer. In the settings section most of the functionality on the user-side is set. The application of the client side 101, installs internal Apps and launches internal Apps. In addition, the application 101, operates calls and messages and shares the application with friends of the user in case it is desirable.

The client side features are:
Dynamic global virtual number & dialer
Hidden multiple social Apps and communication instances (email, social)
Hidden File-system (mostly gallery), camera, contacts
Recommended Apps internal store
Anonymous browsing
Hidden e-Wallet or payment methods
Anonymous cloud-storage
Controlled hours and places
Environment backup & restore
Manage several numbers simultaneously
One-time number, no caller ID (with or wo a client)
Run a Voicemail
Tagging and adding comments to calls (callers)
Services given by server on the client side:
   Outgoing international one-time calls
   Private “Cyber” VPN (checks all traffic content, pass it encrypted through our proxy)
   Find a new friend (location-based chat & video rooms)

The general responsibilities of the application server 103, are as follows:
Follow procedures, running on the Clients, such as:
   a) User accounts: enrollment, billing
   b) Cloud storage management
   c) Backup & restore
   d) Find-new-friends rooms
   e) Integration with 3rd party Apps
   Communicate via protocols with the different system in the client side.
   f) On-line registration
   g) Billing and payment methods
   h) Devices Management (MDM)—for organizational workspace packages management
   i) Outgoing international one-time calls
Configure and manage the Virtual phone lines pool and allocation to subscribers.
PBX (Private Branch Exchange) and signaling of calls
Graphically demonstrate the system operation through on-line process results, and accumulated statistics. Have management reports: statistics for technical (e.g. load), accounting and marketing purposes

In an embodiment of the invention, the communication management unit 325 (Virtual phone lines management) is responsible for:
Configure and manage the Virtual phone lines pool and allocation to subscribers. The DID's are managed through API's.
The client installed uses a soft phone embedded element. Once the user selects his DID area code during the setup wizard, the soft phone gets the SIP configuration from the DB and configure the soft phone with these parameters.
The virtual phone can do call fall back to circuit switch call if the WiFi or packet switch service have limited service and/or long latency.
The circuit switch fall back are determined based on a frequently ping check during the call. If the ping check fails a certain threshold, the corresponding server triggers a circuit switch fall back.

While the invention has been described with respect to a limited number of embodiments, these should not be construed as limitations on the scope of the invention, but rather as exemplifications of some of the embodiments. Those skilled in the art will envision other possible variations, modifications, and programs that are also within the scope of the invention. Accordingly, the scope of the invention should not be limited by what has thus far been described, but by the appended claims and their legal equivalents. Therefore, it should be understood that alternatives, modifications, and variations of the present invention are to be construed as being within the scope of the appended claims.

1. A system for creating one or more additional virtual environment in a mobile device, with a host Operation System operating in a host environment, said system comprises:
a. a client application for allowing the user to interface with said additional virtual environment;
b. a server application with a backend system management unit, which communicates with said client application and manages the operations of said client application;
c. a server data base which contains sets of tables with end users information and transactions;
d. a DID provider which provides the DID numbers and a set of API's which communicates with the server DB;
e. a communication sub-system which manages the communication of said virtual environment;
f. a storage server which contains user files containing user related data which is generated by said user; and
g. a virtualization engine which enables a degree of virtualization of said client application;
wherein said client application is downloaded to said mobile device, and requests a resources allocation according to a predetermined threshold from said host Operation System to emulate a virtual Operation System; said client application is installed in said virtualization engine and collects data parameters and setting of said mobile device and information about said user; said server application preinstalls applications to be executed by said virtual environment of said user according to said user profile and to the collected data parameters and setting and said user information;
wherein said backend system management unit generates a sandbox for running said client application to isolate the virtual Operation System and the client application from said host Operation system and to avoid access of the host Operation System to the resources allocated to said client application thereby creating an additional virtual environment; and requesting allocation of resources on demand from said host Operation System to run applications in said virtual environment according to said parameters and settings of the mobile device and according to the user profile data and information.

2. A system according to claim 1, wherein the mobile device with the virtual environment has a second phone number with a single sim-card.

3. A system according to claim 1, wherein the communication sub-system comprises VOIP media relays servers, SIP proxy server, push messaging unit a PBX and voice engine and a communication management and billing unit and a backend system management unit.

4. A system according to claim 1, wherein the additional virtual environment is secured and hidden from unauthorized persons.

5. A system according to claim 1, wherein the server application creates a new identity for the user so that the additional environment contains an additional phone number and line with messages and applications that are already downloaded on the main environment of the mobile device.

6. A system according to claim 1, wherein the additional virtual environment comprises several layers of security to the user, for hiding private information and identities from people related to said user.

7. A system according to claim 1, further comprising a camera on the additional environment which automatically stores pictures in a safe and hidden repository.

8. A method for creating one or more additional virtual environment in a mobile device, with a host environment and a host Operation System, said method comprises the steps of:
a. downloading a client application to said mobile device and registering to said application to create a user profile, which is saved in a server application which manages the operations of said client application and gaining access to a virtualization engine from said host Operation System;
b. requesting resources allocation from said host Operation System according to a predefined threshold to emulate a virtual Operation System, serving said virtual environment, enabling said virtual Operation System to run one or more applications;
c. collecting data parameters and setting of said mobile device;
d. collecting information about the user;
e. pre-installing applications and mobile environment of said user according to the user profile and to the collected data and information;
f. isolating said virtual Operation System to avoid access of said host operation System to the resources allocated to said client application, by generating a sandbox for running said dedicated client application, thereby creating a virtual environment; and
g. requesting allocation of resources on demand from said host Operation System to run applications in said virtual environment, according to said parameters and settings of the mobile device and according to the user profile data and information.

9. A method according to claim 8, wherein the mobile device with the virtual environment has a second phone number with a single sim-card.

10. A method according to claim 8, wherein the server application creates a new identity for the user so that the additional environment contains an additional phone number and line with messages and applications that are already downloaded on the main environment of the mobile device.

11. A method according to claim 8, wherein the additional virtual environment comprises several layers of security to the user, for hiding private information and identities from people related to said user.
